(19) United States
(12) Patent Application Publication
(10) Pub. No.: US 2014/0096742 A1
(43) Pub. Date: Apr. 10, 2014

(54) Rotating Valve System for a Hydrogen Engine

(71) Applicant: Larry D. WEBB, Wichita, KS (US)

(72) Inventor: Larry D. WEBB, Wichita, KS (US)

(21) Appl. No.: 14/049,179

(22) Filed: Oct. 8, 2013

Related U.S. Application Data
(60) Provisional application No. 61/710,831, filed on Oct. 8, 2012.

(51) Int. Cl. F02M 25/022

(52) U.S. Cl. CPC F02M 25/022
USPC 123/25 R

(57) ABSTRACT

A rotating valve system for a hydrogen engine is an apparatus that generates rotation power by combusting a hydrogen-air mixture. The apparatus includes an engine block, an at least one rotating valve assembly, a plurality of internal combustion (IC) mechanisms, and a crankshaft. The engine block is a structural base for the other components of the apparatus. The IC mechanisms convert the chemical energy of hydrogen into mechanical energy. The crankshaft receives the linear motion from the IC mechanisms and coverts the linear motion into rotational motion. The rotating valve assembly includes an intake tube and an exhaust tube, both with ports that are aligned and timed to deliver a charge of air/fuel mixture to the proper IC mechanism during the intake cycle and to scavenge the exhaust gases from the proper IC mechanism during the exhaust cycle.

The current application claims a priority to the U.S. Provisional Patent application Ser. No. 61/710,831 filed on Oct. 8, 2012.

### FIELD OF THE INVENTION

The present invention relates generally to the field of automotive motors. More specifically, the present invention is an engine that uses gaseous hydrogen as the fuel source in a more efficient system than current poppet valve systems currently in production.

### BACKGROUND OF THE INVENTION

Automobiles and engines have been around for centuries. Gasoline engines have been the most popular and common engines used in vehicles however with expensive gas prices, several alternative fuel motors have been introduces. The most common alternative engines are hybrid engines; however these engines and their batteries can be harmful to the environment during production. Gasoline engines are now very expensive to run for consumers and have low fuel efficiency. Hydrogen powered engines are currently in production however present some efficiency issues. It is therefore an object of the present invention to introduce an apparatus of an automotive engine that uses hydrogen as the fuel source but in a much more efficient system than current poppet valve systems currently in production. Another object of the present invention is to emit virtually zero harmful emissions.

### BRIEF DESCRIPTION OF THE DRAWINGS

FIG. 1 is a front perspective view of the present invention.

FIG. 2 is a back perspective view of the present invention.

FIG. 3 is a front perspective view without the cylinder heads and the engine block.

FIG. 4 is a back perspective view without the cylinder heads and the engine block.

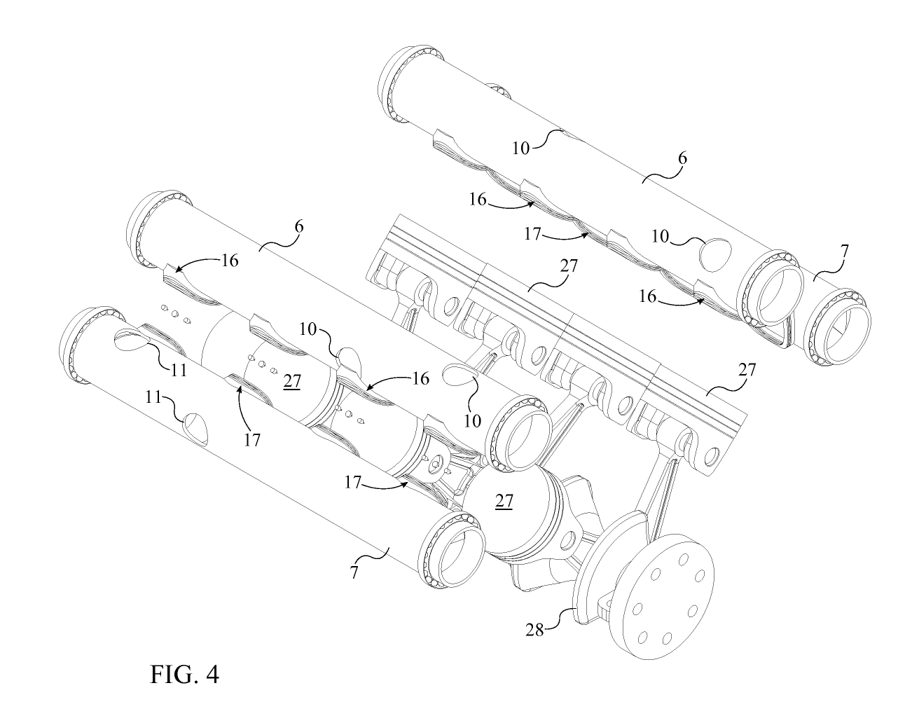

FIG. 5 is a front perspective view without the cylinder heads, the engine block, the intake tube, and the exhaust tube.

FIG. 6 is a back perspective view without the cylinder heads and the engine block, the intake tube, and the exhaust tube.

FIG. 7 is a back perspective view of the rotating valve assembly and the internal combustion mechanisms for the present invention.

FIG. 8 is a back perspective view of the rotating valve assembly and the internal combustion mechanisms without the cylinder head.

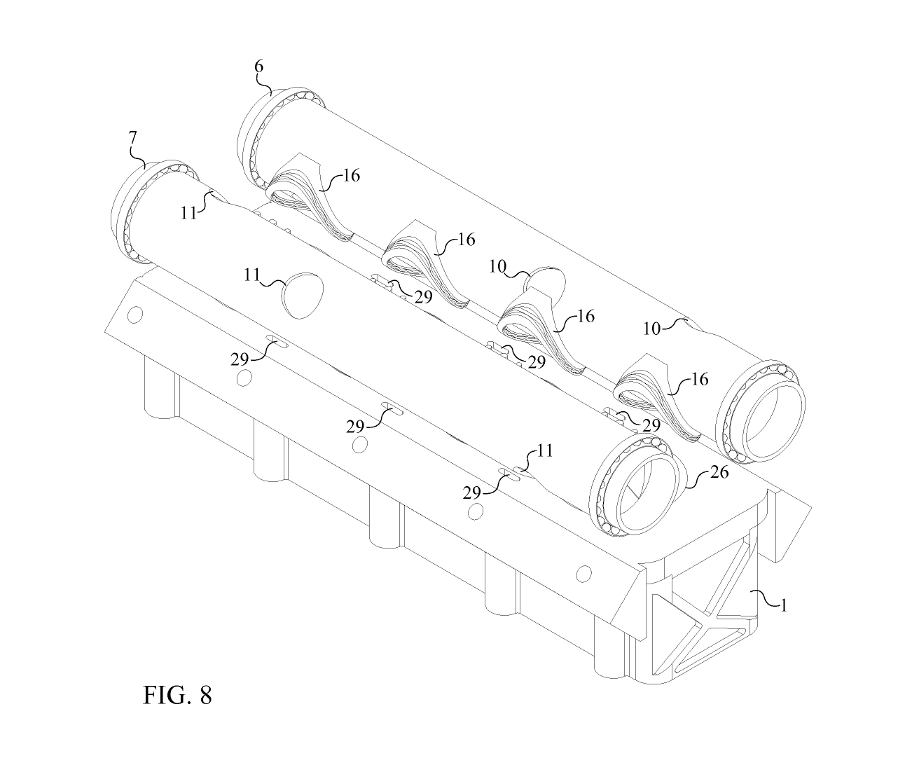

FIG. 9A is a traversal cross-sectional view through the center of one internal combustion mechanism for the present invention.

FIG. 9B is a traversal cross-sectional view between two internal combustion mechanism for the present invention.

FIG. 10 is a longitudinal cross-section view through the center of the plurality of internal combustion mechanisms.

FIG. 11 is a perspective view of the internal structure of an exhaust tube for the present invention.

### DETAILED DESCRIPTIONS OF THE INVENTION

All illustrations of the drawings are for the purpose of describing selected versions of the present invention and are not intended to limit the scope of the present invention.

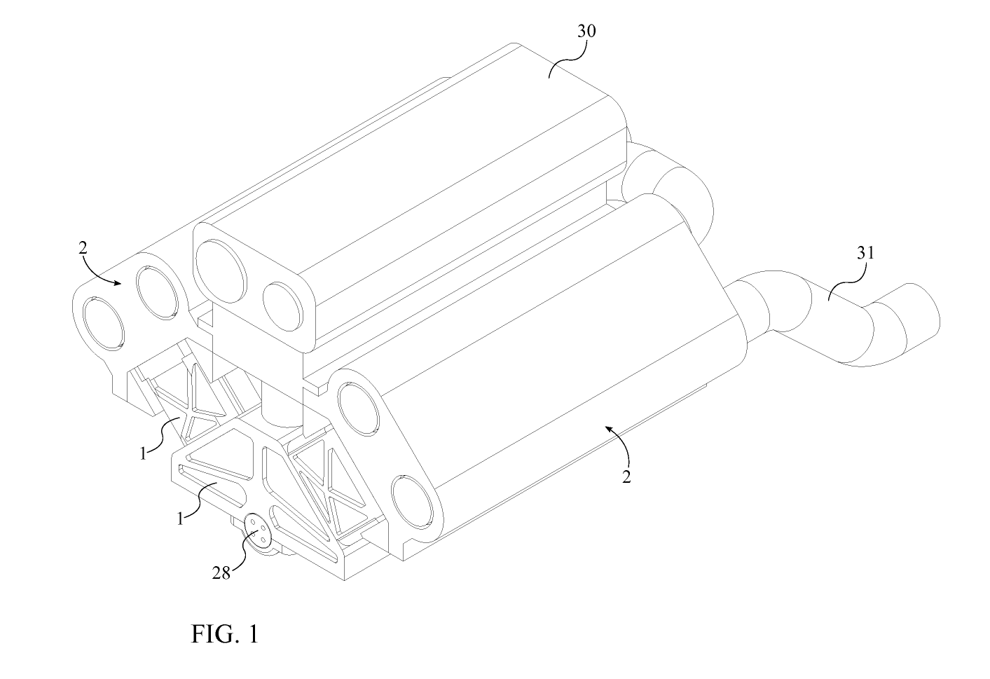

As can be seen in FIGS. 1, 2, and 9A, the present invention is a rotating valve system for a hydrogen engine, which uses hydrogen as a fuel instead of typical fossil fuels. The present invention is designed to be safe for the environment because the present invention has virtually zero harmful emissions. The present invention is also designed to be more efficient at inputting air and extracting fumes from the internal combustion system of the present invention. The present invention mainly comprises an engine block 1, an at least one rotating valve assembly 2, a plurality of internal combustion (IC) mechanisms 9, a crankshaft 28, a supercharger 30, and an exhaust system 31. The engine block 1 is used as the structural base for the moving components of the present invention. In the preferred embodiment of the present invention, the engine block 1 is based on a typical American V8 configuration using aluminum or carbon fiber composites as the raw material for the engine block 1. The plurality of IC mechanisms 9 uses a four stroke cycle to convert the chemical energy from combusting hydrogen into mechanical energy. The four stroke cycle followed by each of the plurality of IC mechanisms 9 includes an intake stroke, a compression stroke, a power stroke, and an exhaust stroke. The crankshaft 28 converts the linear motion produced by the plurality of IC mechanisms 9 into rotational motion that can be used as the engine's output. The at least one rotating valve assembly 2 uses two rotating tubes in order to periodically input air and to periodically extract fumes from each of the plurality of IC mechanisms 9. In preferred embodiment, the at least one rotating valve assembly 2 would include a first rotating valve assembly for one set of pistons within the typical American V8 configuration and would include a second rotating valve assembly for the other set of pistons within the typical American V8 configuration. The supercharger 30 is used to ram more air into the plurality of IC mechanisms 9 in addition to the typical amount of air being vacuumed into the plurality of IC mechanisms 9. Finally, the exhaust system 31 is used to remove fumes from each of the plurality of IC mechanisms 9.

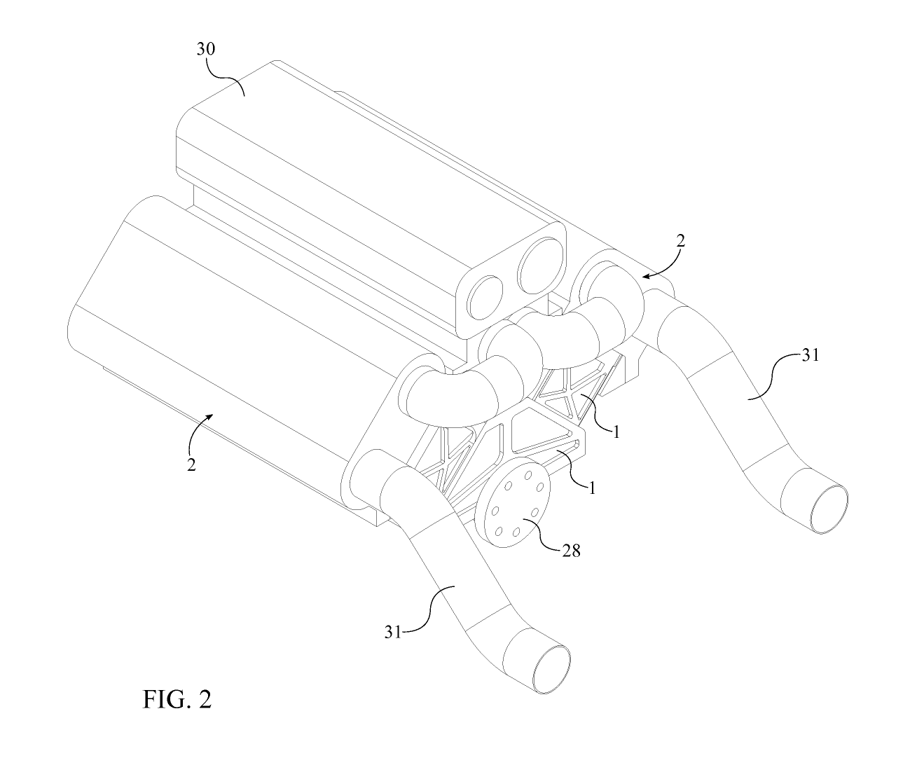

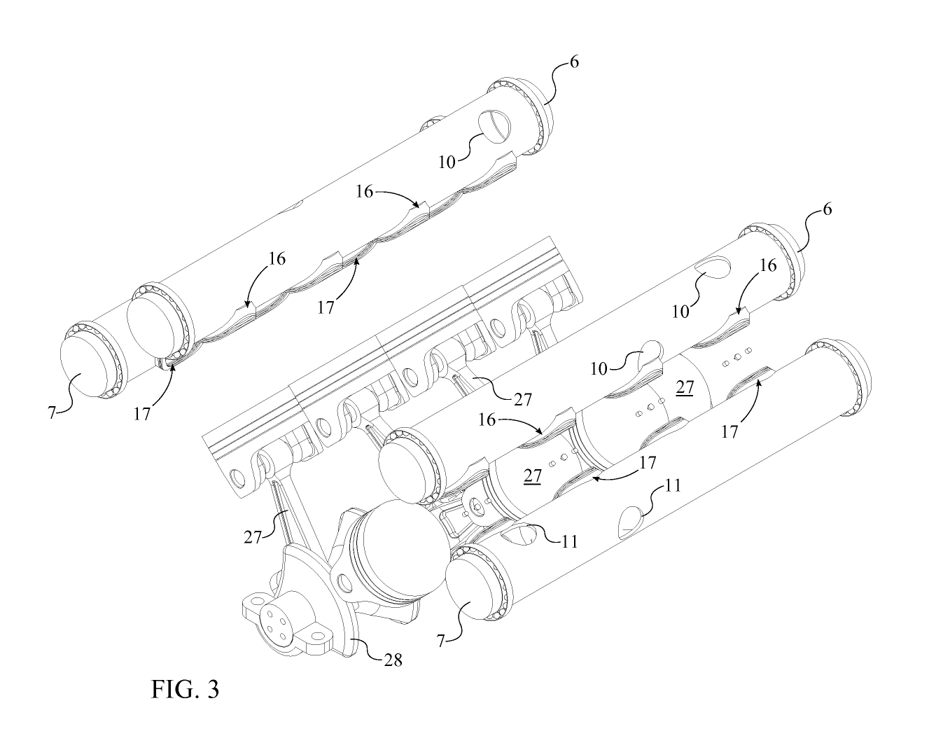

The general configuration of the present invention allows its components to mechanical move without obstructing each other, which is illustrated in FIGS. 2 and 3. The plurality of IC mechanisms 9 is evenly distributed along the engine block 1, which allows the engine block 1 to provide equal structural support to each of the plurality of IC mechanisms 9 and to evenly conduct the heat generated by the plurality of IC mechanisms 9. The at least one rotating valve assembly 2 is mounted above and inline with the plurality of IC mechanisms 9 so that the at least one rotating valve assembly 2 is proximally located to the plurality of IC mechanisms 9 and, thus, can easily intake air or exhaust fumes from the plurality of IC mechanisms 9. The crankshaft 28 is rotatably mounted along the engine block 1 and below the plurality of IC mechanisms 9 so that the crankshaft 28 is proximally located to the plurality of IC mechanisms 9 and, thus, can easily receive the linear motion from the plurality of IC mechanisms 9 and covert that linear motion into rotational motion. More specifically, a piston 27 for each of the plurality of IC mechanisms 9 is mechanically coupled to the crankshaft 28, usually, by a connecting rod. This allows the piston 27 to transfer its linear motion to the crankshaft 28 and allows the piston 27 to rotate the crankshaft 28. This also allows the piston 27 to reciprocate in its linear motion during the four stroke cycle.

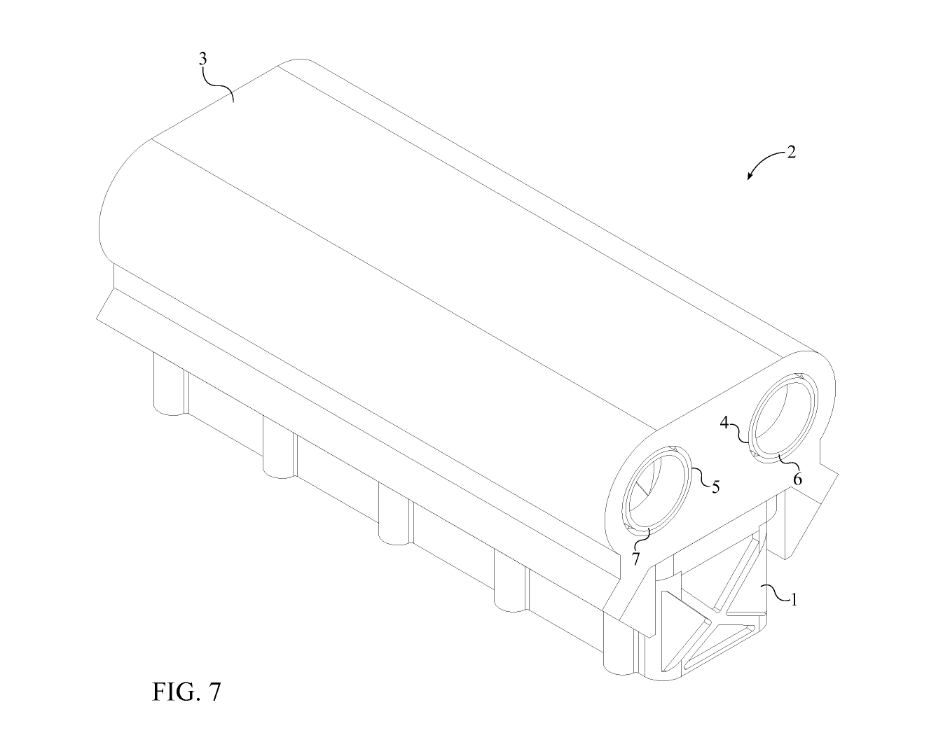

The at least one rotating valve assembly 2 allows the plurality of IC mechanisms 9 to periodically intake air from the supercharger 30 and to periodically exhaust fumes into the exhaust system 31. The at least one rotating valve assembly 2 comprises a cylinder head 3, an intake channel 4, an exhaust channel 5, an intake tube 6, and an exhaust tube 7, which are shown in FIG. 7. The cylinder head 3 is used as a structural base for the at least one rotating valve assembly 2 and is used to cap the plurality of IC mechanisms 9. The intake channel 4 and the exhaust channel 5 traverse through the cylinder head 3 above the plurality of IC mechanisms 9 and are used to respectively house the intake tube 6 and the exhaust tube 7. The intake channel 4 and the exhaust channel 5 are positioned parallel to each other so that the intake tube 6 and the exhaust tube 7 can operate without interfering with each other. Moreover, the intake channel 4 delivers air into the intake tube 6, and, thus, the supercharger 30 needs to be in fluid communication with the intake channel 4. The intake tube 6 is rotatably mounted within the intake channel 4 so that the intake tube 6 can rotate and periodically allow each of the plurality of IC mechanisms 9 to intake air. The exhaust channel 5 also removes the fumes from the exhaust tube 7, and, thus, the exhaust system 31 needs to be in fluid communication with the exhaust channel 5. Similarly, the exhaust tube 7 is rotatably mounted within the exhaust channel 5 so that the exhaust tube 7 can rotate and periodically allow each of the plurality of IC mechanisms 9 to exhaust fumes. In the preferred embodiment of the present invention, the intake tube 6 and the exhaust tube 7 are rotatably mounted to their respective channel by a pair of bearings. In addition, the intake tube 6 and the exhaust tube 7 are rotationally synchronized and driven by the crankshaft 28 so that each of the plurality of IC mechanisms 9 is able to intake air during the intake stroke and is able to exhaust fumes during the exhaust stroke. In the preferred embodiment, the intake tube 6 and the exhaust tube 7 is rotationally synchronized to said crankshaft 28 by a gears-and-chain system. Also in the preferred embodiment, the cylinder head 3 is manufactured as three longitudinal sections, which cut the intake channel 4 in half and the exhaust channel 5 in half.

As can be seen in FIGS. 1 and 2, the supercharger 30 compresses the air entering into intake tube 6 and is ideally mounted atop the engine block 1. Air is taken into the present invention by the throttle body, which then feeds air into the supercharger 30. In the preferred embodiment of the present invention, the supercharger 30 has a physical mount that allows the supercharger 30 to be attached to the top of the engine block 1. After the air is compressed by the supercharger 30, the physical mount has an inter-cooling plenum that is used to hold the compressed air before entering the intake tube 6. The physical mount also has an opening that allows the compressed air to flow out of the physical mount and into the intake tube 6. Also in the preferred embodiment, the supercharger 30 is a twin screw supercharger 30.

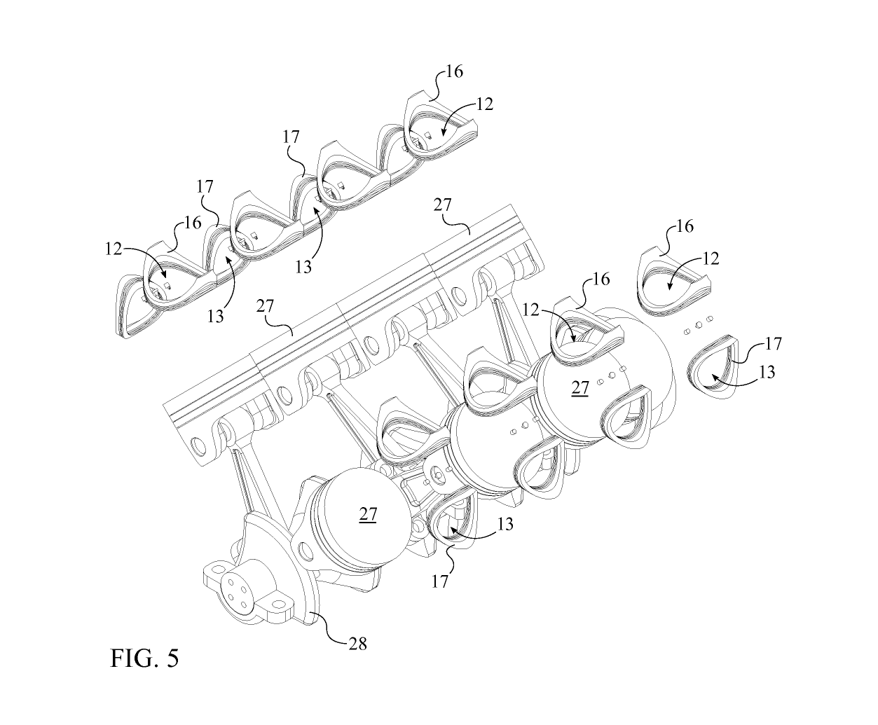

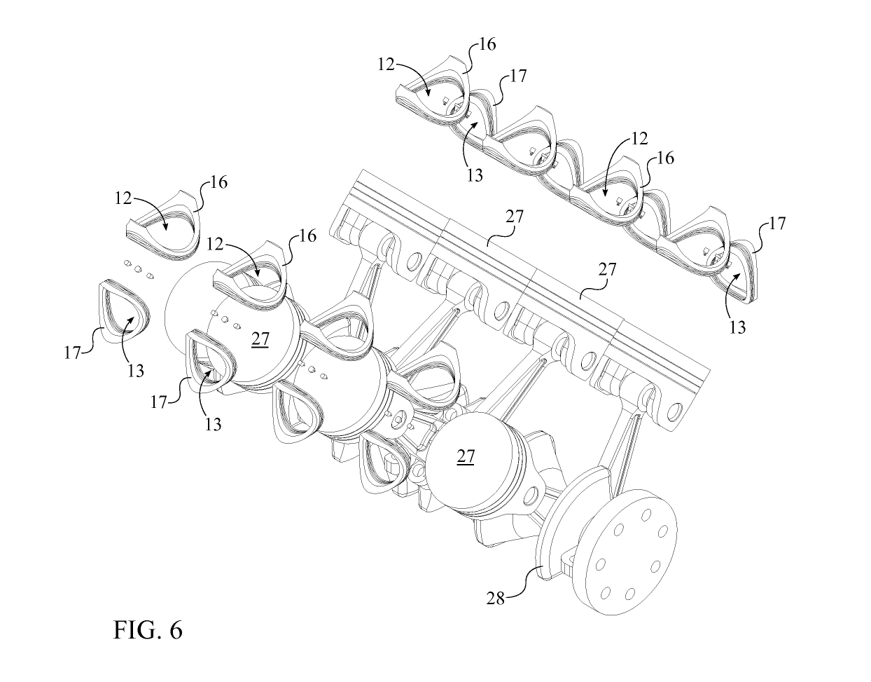

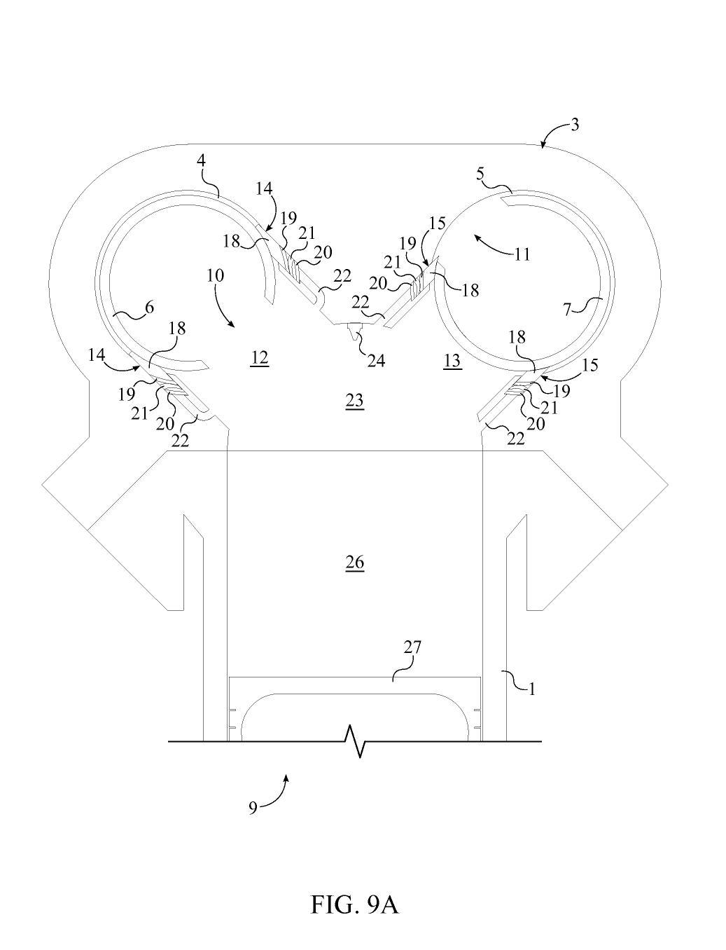

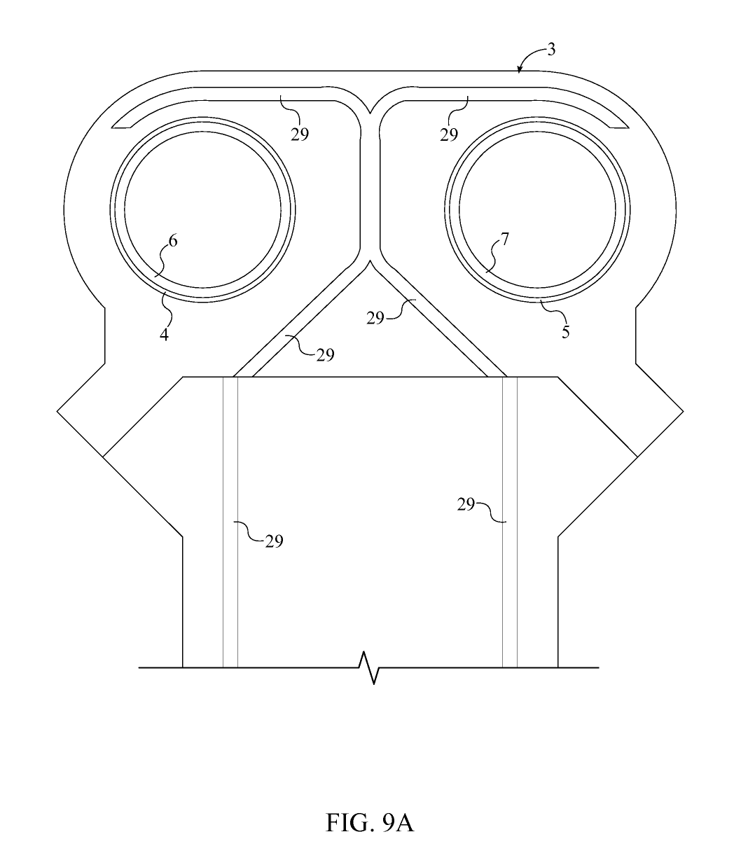

Each of the plurality of IC mechanisms 9 is a collection of components that are used to generate mechanical power by combusting compressed hydrogen. The plurality of IC mechanisms 9 is repetitively fired in a sequential order, which provides the crankshaft 28 with continuous mechanical power as can be seen in FIGS. 5 and 6. Thus, each of the plurality of IC mechanisms 9 comprises an intake tube port 10, an exhaust tube port 11, an intake head port 12, an exhaust head port 13, an intake sealing assembly 16, an exhaust sealing assembly 17, a hemispherical cavity 23, a hydrogen injector 24, an at least one spark plug 25, a combustion chamber 26, and a piston 27. In reference to FIG. 9A, the combustion chamber 26 is used to contain and direct the small explosion of hydrogen towards the piston 27 so that only the piston 27 will move as a result of the expansive force from the small explosion of hydrogen. The combustion chamber 26 is also used to contain the fuel-air mixture during the intake stroke and the compression stroke and to contain the explosion fumes during the power stroke and the exhaust stroke. Consequently, the combustion chamber 26 is positioned perpendicular to both the intake channel 4 and the exhaust channel 5. The combustion chamber 26 is also positioned below and between the intake channel 4 and the exhaust channel 5. This efficiently and effectively configures the combustion chamber 26 with respect to the intake channel 4 and the exhaust channel 5. The piston 27 is slidably engaged within the combustion chamber 26 so that the piston 27 can only move in only one linear direction. Thus, the piston 27 will move towards crankshaft 28 during the power stroke and force the crankshaft 28 to rotate. In preferred embodiment of the present invention, the piston 27 is slidably engaged to the combustion chamber 26 by piston rings that encircle the piston 27 and act as an interface between the piston 27 and the combustion chamber 26. The hemispherical cavity 23 is the roof of the combustion chamber 26 and allows the air to enter across the combustion chamber 26 for a better air-fuel mixture. The hemispherical cavity 23 traverses into the cylinder head 3 perpendicular to both the intake channel 4 and the exhaust channel 5 and is concentrically positioned with the combustion chamber 26, which allows the hemispherical cavity 23 to cap the combustion chamber 26.

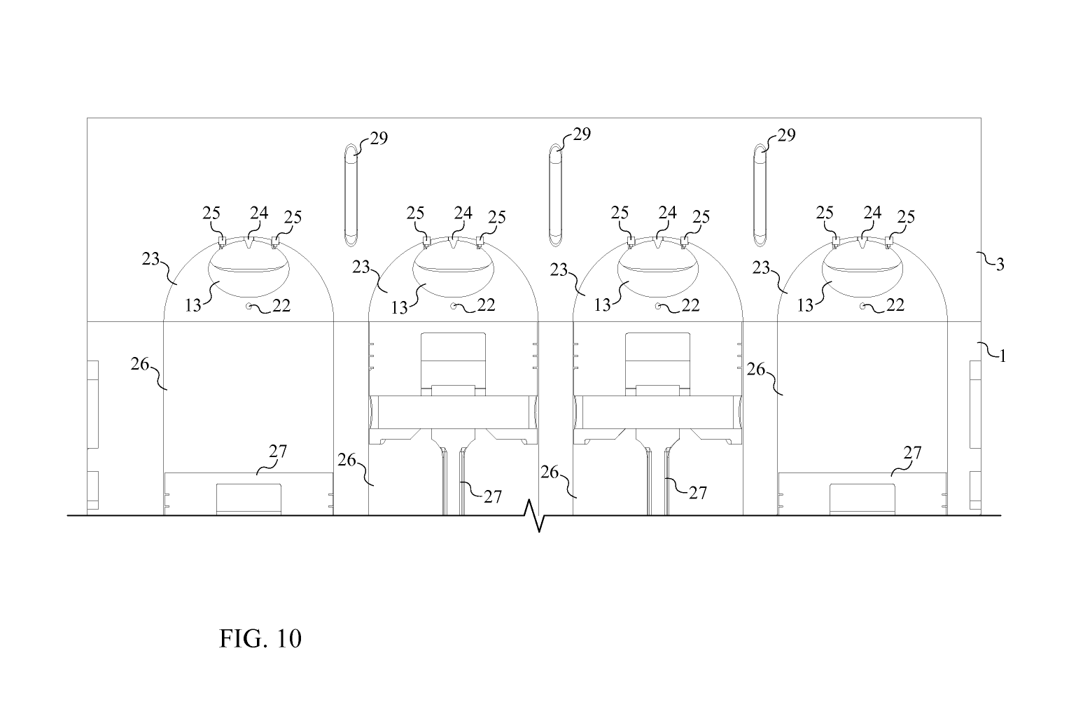

As can be seen in FIG. 10, the components of an IC mechanism that protrude into the combustion chamber 26 include the hydrogen injector 24 and the at least one spark plug 25. The hydrogen injector 24 is used to dispense hydrogen into the combustion chamber 26 during the intake stroke in order to create the proper air-fuel mixture. The hydrogen injector 24 centrally traverses into the hemispherical cavity 23 so that the hydrogen injector 24 is able to evenly dispense the hydrogen through the entire volume of the combustion chamber 26. The hydrogen injector 24 is also mounted to the cylinder head 3 in order to keep the hydrogen injector 24 from interfering with the movement of the piston 27. The hydrogen injector 24 of each of the plurality of IC mechanisms 9 acts as the fuel delivery system for the present invention. The at least one spark plug 25 is used to ignite the compressed air-fuel mixture at the beginning of the power stroke. The at least one spark plug 25 traverses into the hemispherical cavity 23 adjacent to the hydrogen injector 24 and is mounted to the cylinder head 3 in order to similarly keep the at least one spark plug 25 from interfering with the movement of the cylinder head 3. In the preferred embodiment of the present invention, the at least one spark plug 25 includes a first spark plug and a second spark plug, which are positioned on either side of the hydrogen injector 24.

In reference to FIGS. 5 and 6, the intake tube 6 is in periodic fluid communication the hemispherical cavity 23 through the intake tube port 10, through the intake sealing assembly 16, and through the intake head port 12, which allows air to flow from the intake tube 6 into the combustion chamber 26 during the intake stroke. The intake head port 12 is a tunnel that traverses through the cylinder head 3 from the hemispherical cavity 23 to the intake channel 4. The intake tube port 10 is a hole that perpendicularly traverses into the intake tube 6. This configuration allows the intake tube port 10 to align with the intake head port 12 during the intake stroke, which allows air to flow from the intake tube 6 into the combustion chamber 26. The intake head port 12 is hermetically coupled to the intake tube 6 by the intake sealing assembly 16 so that air cannot escape into the intake channel 4 while air is flowing from the intake tube 6 into the combustion chamber 26. The intake annular recess 14 is used to hold the intake sealing assembly 16 in place, which allows the intake head port 12 to be sealed off against the intake tube 6 during the compression stroke, the power stroke, and the exhaust stroke and allows the intake sealing assembly 16 to prevent leakage between the intake tube port 10 and the intake head port 12 during the intake stroke. Thus, the intake sealing assembly 16 is mounted from intake annular recess 14, which traverses into the cylinder head 3 from the intake channel 4 and encircles the intake head port 12.

The intake sealing assembly 16 is able to vary its sealing strength according to current stroke of an IC mechanism. The intake sealing assembly 16 comprises an interface 18, a top shim 19, a bottom shim 20, a wave spring 21, and a plurality of gas-jet ports 22, which are shown in FIG. 9A. The interface 18 is the primary means to restrict the fluid flow between only the intake tube port 10 and the intake head port 12. The interface 18 is positioned into the intake annular recess 14 and protrudes from the intake annular recess 14 into the intake channel 4, which allows the intake tube 6 to be rotatably braced by the interface 18. The interface 18 is shaped on one end to have a circular cross section so that the interface 18 can be inserted into the intake annular recess 14. The interface 18 is shaped on the other end to have a traversal concave cut so that the interface 18 can rotatably brace the intake tube 6. The wave spring 21 is positioned in between the interface 18 and the bottom of the intake annular recess 14, which allows the wave spring 21 to press the interface 18 against the intake tube 6. The top shim 19 and the bottom shim 20 sandwich the wave spring 21 in order to evenly apply pressure from the wave spring 21 on the interface 18 through the top shim 19 and to evenly apply pressure from the wave spring 21 on the bottom of the intake annular recess 14 through the bottom shim 20. Thus, the bottom shim 20, the wave spring 21, the top shim 19, and then the interface 18 are sequentially positioned into the intake annular recess 14. Moreover, the plurality of gas-jet ports 22 is tunnels that traverse through the cylinder head 3, from the intake annular recess 14 to the hemispherical cavity 23, which allows the current fluid within the combustion chamber 26 to travel through the plurality of gas-jet ports 22 during the compression stroke and the power stroke. Consequently, the current fluid will push against the bottom shim 20 and further press the interface 18 against the intake tube 6 during the compression stroke and the power stroke. The plurality of gas-jet ports 22 is also evenly distributed around the intake annular recess 14 so that the current fluid will evenly push against the bottom shim 20.

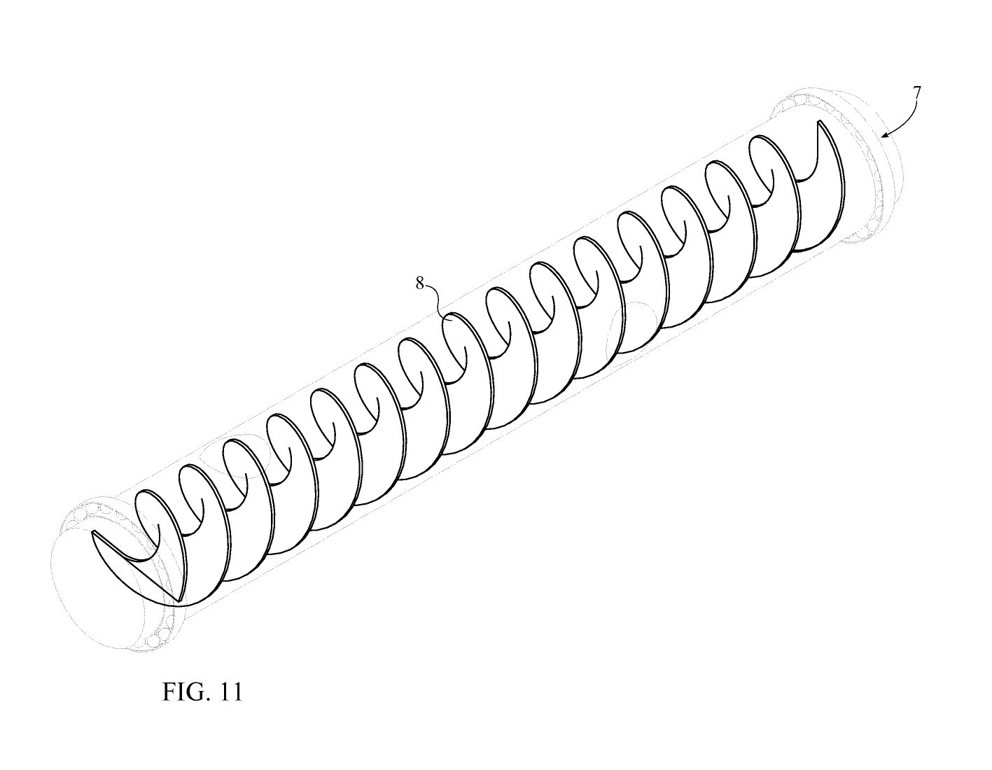

Likewise, the exhaust tube 7 is in periodic fluid communication the hemispherical cavity 23 through the exhaust tube port 11, through the exhaust sealing assembly 17, and through the exhaust head port 13, which allows the fumes to flow from the combustion chamber 26 into the exhaust tube 7 during the exhaust stroke. The exhaust head port 13 is a tunnel that traverses through the cylinder head 3 from the hemispherical cavity 23 to the exhaust channel 5. The exhaust tube port 11 is a hole that perpendicularly traverses into the exhaust tube 7. This configuration allows the exhaust tube port 11 to align with the exhaust head port 13 during the exhaust stroke, which allows the fumes to flow from the combustion chamber 26 into the exhaust tube 7. The exhaust head port 13 is hermetically coupled to the exhaust tube 7 by the exhaust sealing assembly 17 so that fumes cannot escape into the exhaust channel 5 while the fumes are flowing from the combustion chamber 26 into the exhaust tube 7. The exhaust annular recess 15 is used to hold the exhaust sealing assembly 17 in place, which allows the exhaust head port 13 to be sealed off against the exhaust tube 7 during the intake stroke, the compression stroke, and the power stroke and allows the exhaust sealing assembly 17 to prevent leakage between the exhaust tube port 11 and the exhaust head port 13 during the exhaust stroke. Thus, the exhaust sealing assembly 17 is mounted from exhaust annular recess 15, which traverses into the cylinder head 3 from the exhaust channel 5 and encircles the exhaust head port 13. Different from the intake tube 6, the exhaust tube 7 comprises a helical internal structure 8, which is positioned along and within the exhaust tube 7. As can be seen in FIG. 11, the helical internal structure 8 is used to further assist the piston 27 in removing the fumes during the exhaust stroke by creating a vortex within the exhaust tube 7. During the exhaust stroke, the vortex will vacuum the fumes out of the combustion chamber 26 while the piston 27 pushes the fumes out of the combustion chamber 26.

Similar to the intake sealing assembly 16, the exhaust sealing assembly 17 is able to vary its sealing strength according to current stroke of an IC mechanism. The exhaust sealing assembly 17 also comprises an interface 18, a top shim 19, a bottom shim 20, a wave spring 21, and a plurality of gas-jet ports 22. The interface 18 is the primary means to restrict the fluid flow between only the exhaust tube port 11 and the exhaust head port 13. The interface 18 is positioned into the exhaust annular recess 15 and protrudes from the exhaust annular recess 15 into the exhaust channel 5, which allows the exhaust tube 7 to be rotatably braced by the interface 18. The interface 18 is shaped on one end to have a circular cross section so that the interface 18 can be inserted into the exhaust annular recess 15. The interface 18 is shaped on the other end to have a traversal concave cut so that the interface 18 can rotatably brace the exhaust tube 7. For both the intake sealing assembly 16 and the exhaust sealing assembly 17, the interface 18 is preferably cast from a silicone nitrate material, which is able to withstand the high engine temperatures and is a self lubricating material. The wave spring 21 is positioned in between the interface 18 and the bottom of the exhaust annular recess 15, which allows the wave spring 21 to press the interface 18 against the exhaust tube 7. The top shim 19 and the bottom shim 20 sandwich the wave spring 21 in order to evenly apply pressure from the wave spring 21 on the interface 18 through the top shim 19 and to evenly apply pressure from the wave spring 21 on the bottom of the exhaust annular recess 15 through the bottom shim 20. Thus, the bottom shim 20, the wave spring 21, the top shim 19, and then the interface 18 are sequentially positioned into the exhaust annular recess 15. For both the intake sealing assembly 16 and the exhaust sealing assembly 17, the wave spring 21 could also be replaced by a plurality of springy tangs connected to either the top shim 19 or the bottom shim 20. Moreover, the plurality of gas-jet ports 22 is tunnels that traverse through the cylinder head 3, from the exhaust annular recess 15 to the hemispherical cavity 23, which allows the current fluid within the combustion chamber 26 to travel through the plurality of gas-jet ports 22 during the compression stroke and the power stroke. Consequently, the current fluid will push against the bottom shim 20 and further press the interface 18 against the exhaust tube 7 during the compression stroke and the power stroke. The plurality of gas-jet ports 22 is also evenly distributed around the exhaust annular recess 15 so that the current fluid will evenly push against the bottom shim 20.

In reference to FIG. 9B, the present invention also comprises a plurality of coolant passages 29, which allows coolant to run throughout the present invention and prevent damage to the components of the present invention from overheating. The plurality of coolant passages 29 traverses through the engine block 1 around the hemispherical cavity 23 and the combustion chamber 26 for each of the plurality of IC mechanisms 9, which reduces the temperature increase from combusting the air-fuel mixture. The plurality of coolant passages 29 traverses through the cylinder head 3 around the intake channel 4 and the exhaust channel 5, which reduces the temperature increase from cramming air into the intake tube 6 and reduces the temperature increase from the heating combustion fumes within the exhaust tube 7.

Although the invention has been explained in relation to its preferred embodiment, it is to be understood that many other possible modifications and variations can be made without departing from the spirit and scope of the invention as hereinafter claimed.

What is claimed is:

1. A rotating valve system for a hydrogen engine comprises:
an engine block;
an at least one rotating valve assembly;
a plurality of internal combustion (IC) mechanisms;
a crankshaft;
a supercharger;
an exhaust system;
said at least one rotating valve assembly comprises a cylinder head, an intake channel, an exhaust channel, an intake tube, and an exhaust tube; and
each of said plurality of IC mechanisms comprises an intake tube port, an exhaust tube port, an intake head port, an exhaust head port, an intake sealing assembly, an exhaust sealing assembly, a hemispherical cavity, a hydrogen injector, an at least one spark plug, a combustion chamber, and a piston.

2. The rotating valve system for a hydrogen engine as claimed in claim 1 comprises:
said supercharger being mounted atop said engine block;
said supercharger being in fluid communication with said intake channel; and
said exhaust system being in fluid communication with said exhaust channel.

3. The rotating valve system for a hydrogen engine as claimed in claim 1 comprises:
said plurality of IC mechanisms being evenly distributed along said engine block;
said at least one rotating valve assembly being mounted above and inline with said plurality of IC mechanisms;
said crankshaft being rotatably mounted along said engine block and below said plurality of IC mechanisms; and
said piston for each of said plurality of IC mechanisms being mechanically coupled to said crankshaft.

4. The rotating valve system for a hydrogen engine as claimed in claim 1 comprises:
said intake channel and said exhaust channel traversing into said cylinder head above said plurality of IC mechanisms;
said intake channel and said exhaust channel being positioned parallel to each other;
said intake tube being rotatably mounted within said intake channel;
said exhaust tube being rotatably mounted within said exhaust channel; and
said intake tube and said exhaust tube being rotationally synchronized to said crankshaft.

5. The rotating valve system for a hydrogen engine as claimed in claim 1 comprises:
said combustion chamber being positioned perpendicular to said intake channel and said exhaust channel;
said combustion chamber being positioned below and between said intake channel and said exhaust channel;
said piston being slidably engaged within said combustion chamber;
said hemispherical cavity traversing into said cylinder head perpendicular to said intake channel and said exhaust channel; and
said hemispherical cavity being concentrically positioned with said combustion chamber.

6. The rotating valve system for a hydrogen engine as claimed in claim 1 comprises:
said hydrogen injector centrally traversing into said hemispherical cavity;
said hydrogen injector being mounted to said cylinder head;
said at least one spark plug traversing into said hemispherical cavity adjacent to said hydrogen injector; and
said at least one spark plug being mounted to said cylinder head.

7. The rotating valve system for a hydrogen engine as claimed in claim 1 comprises:
said intake tube port perpendicularly traversing into said intake tube;
said intake head port traversing through said cylinder head from said hemispherical cavity to said intake channel;
said intake head port being hermetically coupled to said intake tube by said intake sealing assembly; and
said intake tube being in periodic fluid communication with said hemispherical cavity through said intake tube port, through said intake sealing assembly, and through said intake head port.

8. The rotating valve system for a hydrogen engine as claimed in claim 1 comprises:
said intake annular recess traversing into said cylinder head from said intake channel;
said intake annular recess encircling said intake head port; and
said intake sealing assembly being mounted from said intake annular recess,

9. The rotating valve system for a hydrogen engine as claimed in claim 1 comprises:
said intake sealing assembly comprises an interface, a top shim, a bottom shim, a wave spring, and a plurality of gas-jet ports;
said plurality of gas-jet ports traversing through said cylinder head from said intake annular recess to said hemispherical cavity;
said plurality of gas-jet ports being evenly distributed around the intake annular recess;
said bottom shim, said wave spring, said top shim, and said interface being sequentially positioned into said intake annular recess;
said interface protruding from said exhaust annular recess into said exhaust channel; and
said intake tube being rotatably braced by said interface.

10. The rotating valve system for a hydrogen engine as claimed in claim 1 comprises:
said exhaust tube port perpendicularly traversing into said exhaust tube;
said exhaust head port traversing through said cylinder head from said hemispherical cavity to said exhaust channel;
said exhaust head port being hermetically coupled to said exhaust tube by said exhaust sealing assembly; and
said exhaust tube being in periodic fluid communication with said hemispherical cavity through said exhaust tube port, through said exhaust sealing assembly, and through said exhaust head port.

11. The rotating valve system for a hydrogen engine as claimed in claim 1 comprises:
said exhaust tube comprises a helical internal structure; and
said helical internal structure being positioned along and within said exhaust tube.

12. The rotating valve system for a hydrogen engine as claimed in claim 1 comprises:
said exhaust annular recess traversing into said cylinder head from said exhaust channel;
said exhaust annular recess encircling said exhaust head port; and
said exhaust sealing assembly being mounted from said exhaust annular recess.

13. The rotating valve system for a hydrogen engine as claimed in claim 1 comprises:
said exhaust sealing assembly comprises an interface, a top shim, a bottom shim, a wave spring, and a plurality of gas-jet ports;
said plurality of gas-jet ports traversing through said cylinder head from said exhaust annular recess to said hemispherical cavity;
said plurality of gas-jet ports being evenly distributed around the exhaust annular recess;
said bottom shim, said wave spring, said top shim, and said interface being sequentially positioned into said exhaust annular recess;
said interface protruding from said exhaust annular recess; and
said exhaust tube being rotatably braced by said interface.

14. The rotating valve system for a hydrogen engine as claimed in claim 1 comprises:
a plurality of coolant passages;
said plurality of coolant passages traversing through said engine block around said hemispherical cavity and said combustion chamber for each of said plurality of IC mechanisms; and
said plurality of coolant passages traversing through said cylinder head around said intake channel and said exhaust channel.

15. A rotating valve system for a hydrogen engine comprises:
an engine block;
an at least one rotating valve assembly;
a plurality of internal combustion (IC) mechanisms;
a crankshaft;
a supercharger;
an exhaust system;
said at least one rotating valve assembly comprises a cylinder head, an intake channel, an exhaust channel, an intake tube, and an exhaust tube;
each of said plurality of IC mechanisms comprises an intake tube port, an exhaust tube port, an intake head port, an exhaust head port, an intake sealing assembly, an exhaust sealing assembly, a hemispherical cavity, a hydrogen injector, an at least one spark plug, a combustion chamber, and a piston;
said intake channel and said exhaust channel traversing into said cylinder head above said plurality of IC mechanisms;
said intake channel and said exhaust channel being positioned parallel to each other;
said intake tube being rotatably mounted within said intake channel;
said exhaust tube being rotatably mounted within said exhaust channel; and
said intake tube and said exhaust tube being rotationally synchronized to said crankshaft.

16. The rotating valve system for a hydrogen engine as claimed in claim 15 comprises:
said supercharger being mounted atop said engine block;
said supercharger being in fluid communication with said intake channel;
said exhaust system being in fluid communication with said exhaust channel;
said plurality of IC mechanisms being evenly distributed along said engine block;
said at least one rotating valve assembly being mounted above and inline with said plurality of IC mechanisms;
said crankshaft being rotatably mounted along said engine block and below said plurality of IC mechanisms; and
said piston for each of said plurality of IC mechanisms being mechanically coupled to said crankshaft.

17. The rotating valve system for a hydrogen engine as claimed in claim 15 comprises:
said combustion chamber being positioned perpendicular to said intake channel and said exhaust channel;
said combustion chamber being positioned below and between said intake channel and said exhaust channel;
said piston being slidably engaged within said combustion chamber;
said hemispherical cavity traversing into said cylinder head perpendicular to said intake channel and said exhaust channel;
said hemispherical cavity being concentrically positioned with said combustion chamber;
said hydrogen injector centrally traversing into said hemispherical cavity;
said hydrogen injector being mounted to said cylinder head;
said at least one spark plug traversing into said hemispherical cavity adjacent to said hydrogen injector; and
said at least one spark plug being mounted to said cylinder head.

18. The rotating valve system for a hydrogen engine as claimed in claim 15 comprises:
said intake tube port perpendicularly traversing into said intake tube;
said intake head port traversing through said cylinder head from said hemispherical cavity to said intake channel;
said intake head port being hermetically coupled to said intake tube by said intake sealing assembly;
said intake tube being in periodic fluid communication with said hemispherical cavity through said intake tube port, through said intake sealing assembly, and through said intake head port;
said intake annular recess traversing into said cylinder head from said intake channel;
said intake annular recess encircling said intake head port;
said intake sealing assembly being mounted from said intake annular recess;
said intake sealing assembly comprises an interface, a top shim, a bottom shim, a wave spring, and a plurality of gas-jet ports;
said plurality of gas-jet ports traversing through said cylinder head from said intake annular recess to said hemispherical cavity;
said plurality of gas-jet ports being evenly distributed around the intake annular recess;
said bottom shim, said wave spring, said top shim, and said interface being sequentially positioned into said intake annular recess;
said interface protruding from said exhaust annular recess into said exhaust channel; and
said intake tube being rotatably braced by said interface.

19. The rotating valve system for a hydrogen engine as claimed in claim 15 comprises:
said exhaust tube port perpendicularly traversing into said exhaust tube;
said exhaust head port traversing through said cylinder head from said hemispherical cavity to said exhaust channel;
said exhaust head port being hermetically coupled to said exhaust tube by said exhaust sealing assembly;
said exhaust tube being in periodic fluid communication with said hemispherical cavity through said exhaust tube port, through said exhaust sealing assembly, and through said exhaust head port;
said exhaust tube comprises a helical internal structure;
said helical internal structure being positioned along and within said exhaust tube;
said exhaust annular recess traversing into said cylinder head from said exhaust channel;
said exhaust annular recess encircling said exhaust head port;
said exhaust sealing assembly being mounted from said exhaust annular recess;
said exhaust sealing assembly comprises an interface, a top shim, a bottom shim, a wave spring, and a plurality of gas-jet ports;
said plurality of gas-jet ports traversing through said cylinder head from said exhaust annular recess to said hemispherical cavity;
said plurality of gas-jet ports being evenly distributed around the exhaust annular recess;
said bottom shim, said wave spring, said top shim, and said interface being sequentially positioned into said exhaust annular recess;
said interface protruding from said exhaust annular recess; and
said exhaust tube being rotatably braced by said interface.

20. The rotating valve system for a hydrogen engine as claimed in claim 15 comprises:
a plurality of coolant passages;
said plurality of coolant passages traversing through said engine block around said hemispherical cavity and said combustion chamber for each of said plurality of IC mechanisms; and
said plurality of coolant passages traversing through said cylinder head around said intake channel and said exhaust channel.
